(19) United States
(12) Patent Application Publication
(10) Pub. No.: US 2001/0040994 A1
(43) Pub. Date: Nov. 15, 2001

(54) Counterfeit bills discriminating device with infrared ray transmitting array module and method of discriminating counterfeit bills

(75) Inventors: Sang Hwan Jang, Seoul (KR); Seok Ihn Son, Seoul (KR)

Correspondence Address: Anderson Kill & Olick, 1251 Avenue of the Americas, New York, NY, 10020-1182, US

(73) Assignee: SANG HWAN JANG

(21) Appl. No.: 09/852,454

(22) Filed: May 9, 2001

(30) Foreign Application Priority Data
May 10, 2000 (KR) 2000-13278

(51) Int. Cl. G06K 9/00

(52) U.S. Cl. 382/135

(57) ABSTRACT

The present invention relates to a counterfeit bills discriminating device and a counterfeit bills discrimination method, and more particularly, to a counterfeit bill discriminating device having infrared ray transmitting array and a method of discriminating counterfeit bills. The present invention installs a device that detects counterfeit bills by sensing sorts and conditions of bills based upon data gained from each sensor using sensing devices of inputted bills, and discharges the bills through exhaust ports. The present invention makes it possible to install the device in locations where counterfeit is easy. The device consists of infrared ray LED array and infrared ray sensor array that place sensor module composed of 8 through 32 elements by constant interval.

The above described sensor module produces reference data of light transmittance characteristics upon angles and directions of inputted bills based on data already installed by sampling after sensing angles, directions and sorts of the inputted bills by using various sensors. The device also detects counterfeit bills by analyzing and comparing light transmittance characteristics of bills using special kinds of ink like infrared ray ink and hidden drawings and/or negatively printed pictures, which pass through space between module of light emitting section and module of light receiving section in infrared ray transmitting sensor module.

### BACKGROUND OF THE INVENTION

1. Field of the Invention

The present invention relates to a counterfeit bill discriminating device and a counterfeit bill discrimination method, and more particularly, to a counterfeit bill discriminating device having infrared ray emitting and receiving array modules, to thereby detect the counterfeit bill by analyzing infrared ray transmitting characteristics of the bill passing through the bill transferring passage between the emitting array module and the receiving array module.

2. Description of the Background Art

In recent years, the production of counterfeit currency has dramatically grown due to the advent of color photocopy machines. In general, there have been developed several anti-counterfeiting measures in an automated banking machine, such as a bill counter, an automatic bill sorter, a counterfeit bill sensor. The measures include complicated embossing and micro-printing techniques, and the use of optical scanners capable of detecting minute variances in currency features, such as printing pattern, color and sheet stock material. For example, the measures use the techniques of detecting ultraviolet rays reflected from the sensed bill and of inspecting magnetic patterns on the sensed bill.

However, the measures have the following problems; in the inspection of magnetic patterns, it is difficult to detect copied counterfeit bills because toner of general copy machine has magnetic component. In the detection of ultraviolet rays, it is impossible to discriminate counterfeit bills with the portraits and the patterns printed on a paper treated by ultraviolet rays.

In addition, with the technique of detecting infrared rays reflected or transmitted from the sensed bill, the detection is limited to defined areas on the bill due to the speed of data processing, and the like. Also, the detection becomes unreliable since the detection values vary with the inserting condition of the bills, such as an inserting angle and an inserting position at the inserting slot of the machine.

As described above, in automated banking machine with the conventional techniques of detecting counterfeit bill, it is possible to sense partially the magnetic patterns or ultraviolet rays, but has problems as described above. Moreover, it has the restricted reliability of discriminating counterfeit bills in the case of bills with the patterns printed by special ink for anti-counterfeiting.

### SUMMARY OF THE INVENTION

An object of the present invention is to provide a counterfeit bills discriminating device with higher reliability, and a counterfeit bills discrimination method.

In order to achieve the object, the present invention provides counterfeit bills sensing device installed in the course where bills are inputted into input port and transferred, which is built with infrared ray transmitting LED array and sensor array modules to detect the rate of infrared ray transmitting.

Concretely, the present invention installs infrared ray transmitting LED array placing 8 through 32 elements by constant interval and sensor array module inside the device, flashes light on one side of a bill from the light source, and senses quantity of light comes out from the bill with sensor located in the opposite of the light source. After that, with analyzed data of light transmittance characteristics by comparing reference data produced by sampling, the invention detects counterfeit bills, and contrives improvement of efficiency of detecting counterfeit bills by using infrared ray transmitting.

On the other hand, if the input direction of bills is longitudinal, the invention enables the device to analyze light transmittance characteristics of anterior surface of bills in detail by placing 8 through 16 elements in a line.

Infrared ray transmitting LED array and sensor array modules of the present invention would have better capacity if it is installed in locations like a spot behind the sensor used for discriminating types of bills and surface and back or a place that the device can simply discriminate counterfeit bills by detecting of infrared ray transmitting value among the entire structure of an automated banking machine.

### BRIEF DESCRIPTION OF THE DRAWINGS

FIG. 1 shows a schematic side view of an automated bill detector with a counterfeit bill discriminating device according to the present invention.

FIG. 2 shows a schematic side view of sensor arrangement in the automated bill detector of FIG. 1.

FIG. 3 shows infrared ray sensor body according to the present invention.

FIG. 4 shows a schematic side view of a bill counter in which the counterfeit bill discriminating device of the present invention is embodied.

FIG. 5 shows the light transmittance characteristics of the bill when the bill is inputted laterally.

FIG. 6 shows the light transmittance characteristics of the bill when the bill is inputted longitudinally.

### DETAILED DESCRIPTION OF THE PREFERRED EMBODIMENTS

Referring to the accompanying drawings, a preferred embodiment of the present invention will be described in detail.

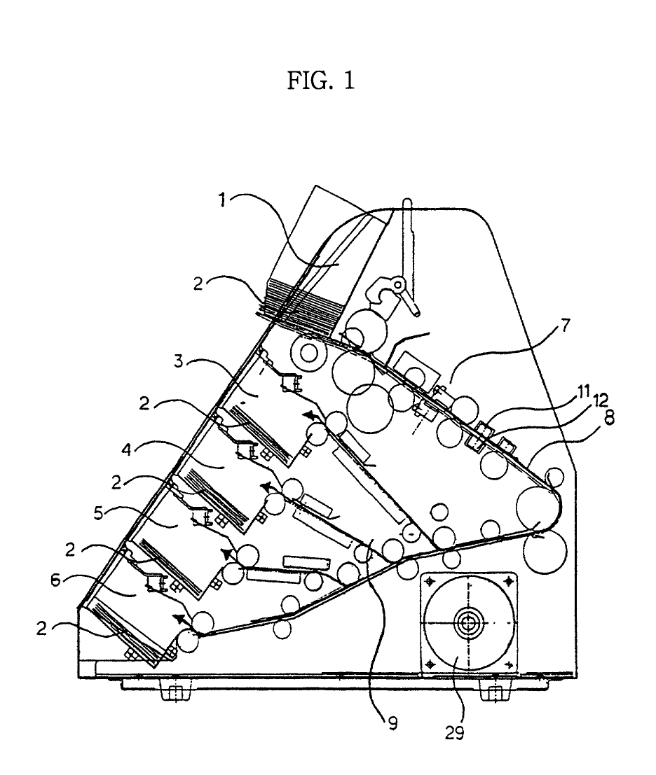

FIG. 1 shows a side view of an automated banking machine with a counterfeit bill discriminating device according to the present invention.

As shown in FIG. 1, an automated bill sorter having a counterfeit bill discriminating device with infrared ray transmitting array modules comprises an input port 1 into which a bundle of bills are inserted, a discriminating part 7, a classifying part 9, a belt and a roller. The discriminating part 7 transfers the bundle of bills inputted into the input port one by one and discriminates each transferred bill. The classifying part 9 sorts the bills passing the discriminating part 7 into classifying pockets step by step by switching operation of a switching blade. The belt and the roller deliver a turning force of a power motor 29 to each turning parts. The discriminating part 7 includes an image sensor for detecting types of bills, insertion position, that is a biased degree to right or left and insertion angle of inputted bills. Based on the data obtained from the image sensor, the discriminating part 7 determines whether the inputted bills are counterfeit or not by the light transmittance characteristics of the bills passing through the opposed rollers arranged immediately after the image sensor and subsequently passing through the passage between infrared ray emitting array module and infrared ray receiving array module.

The bill transferring operation of the automated bill sorter will be described.

When a bundle of bills 2 are inputted into the input port 1, the bills are separated one by one by a roller and moved to the discriminating part 7. In the discriminating part 7, each bill passes successively a image sensor module 10, the thickness detecting roller 30, infrared ray transmitting sensor array module 11 and infrared ray transmitting LED array module 12, MG (magnetic)/UV (ultraviolet) sensor 31 and the bills are moved to the classifying part 9 along the bill transferring passage 8.

As described above, when passing through the discriminating part 7, the discriminating part 7 decides a exhaust port by electrically detecting the information about the bill from the each sensor and discharges the bill through the corresponding exhaust ports 3, 4, 5 and 6 by activating each switching blade according to the decision.

In the above described operation, Central Processing Unit (CPU) with an operating system collects the data from the sensors and determines types of bills, their inputted surface, direction, condition, degree of stain and damage, as well as whether the bills are counterfeit or not.

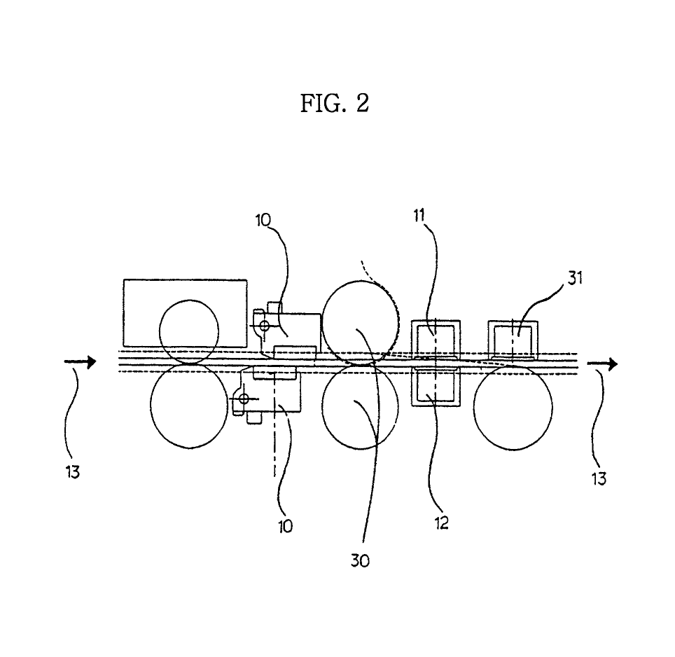

FIG. 2 shows a schematic side view of sensor arrangement in the automated bill detector of FIG. 1.

As illustrated in FIG. 2, the discriminating part 7 determines types of bills, their inputted surface, direction, condition, based on the data obtained from the image sensor module 10 placed at the upstream of the bill transferring passage. With the determination, the discriminating part 7 recognizes the inputted surface, direction, and angle of inputted bills passing through the transferring passage between infrared ray transmitting LED array module 12 and infrared ray transmitting sensor array module 11. In FIG. 2, reference numeral 13 is a bill transferring direction.

Based on the determination results, the CPU calculates the reference data according to the passing condition of bills from the stored sample data and discriminates whether the bill is counterfeit or not by comparing the calculated reference data with the measured data obtained from the infrared ray transmitting sensor array module 11.

Referring to FIG. 1 and 2, more detailed description is given hereinafter. Bills entering the discriminating part 7 pass top and bottom image sensor module 10, wherein the discriminating part 7 detects the image of bills and determines inputting conditions of bills, such as an insertion position, an insertion angle, and the like. In addition, the discriminating part 7 analyzes the image information and determines types and insertion direction of the inputted bills. For example, in case of American dollar currency, it determines the insertion direction from the direction of the portrait. The discriminating part 7 generates reference data of light transmittance characteristics according to the insertion conditions of the inputted bills, which is capable of comparing changes of light transmittance reaction (transmittance level) of bills obtained from each element when the bills pass through infrared ray transmitting sensor array and LED array modules along the bill transferring passage.

Subsequently, the light transmitting the bill is detected when each bill passes through the transferring passage between infrared ray transmitting sensor array module 11 and infrared ray transmitting LED array module 12 after passing the thickness detecting roller 30. By comparing the detected value with a reference level, the discriminating part 7 determines whether the bill is counterfeit or not. At this time, since there are some differences in reference level of light transmittance according to the condition of bills, the discriminating part 7 defines a predetermined allowable range. The discriminating part 7 determines that the bill is genuine if the detected light transmittance is within the allowable range. Otherwise it determines that the bill is counterfeit.

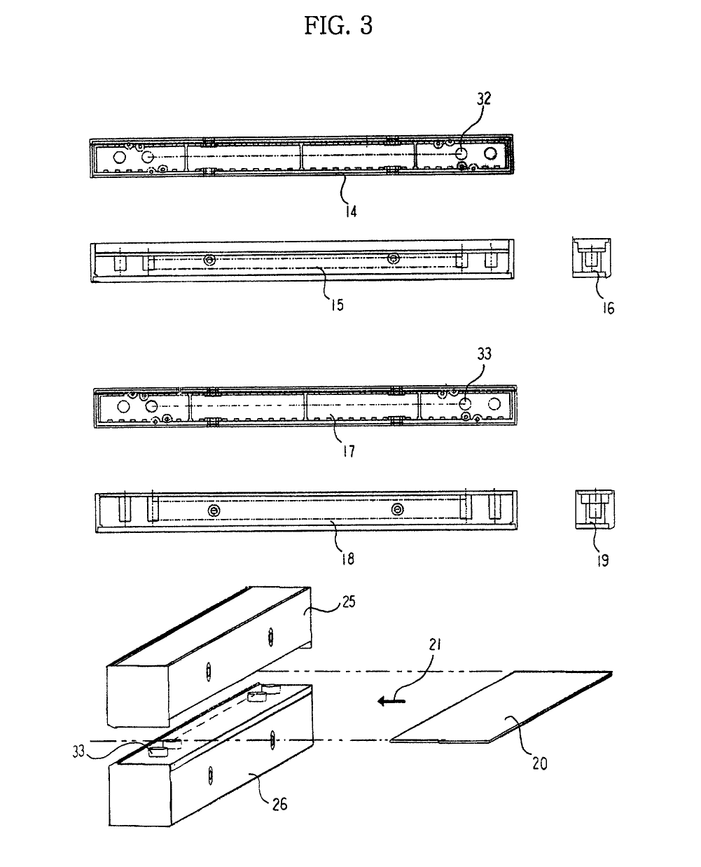

FIG. 3 is a drawing illustrating infrared ray transmitting sensor array module and infrared ray transmitting LED array module body according to the present invention. The array modules can be assembled so that the detection range is adjustable according to the number and the spacing of the elements, to thereby detect the infrared ray transmittance in a suitable range with different types of bills. In FIG. 3, reference numeral 14 is a front view of infrared ray transmitting sensor array module. Reference numeral 15 is a lateral side view of infrared ray transmitting sensor array module, 16 is a longitudinal side view of infrared ray transmitting sensor array module, 17 is a front view of infrared ray transmitting LED array module, 18 is a lateral side view of infrared ray transmitting LED array module, 19 is a longitudinal side view of infrared ray LED array module, and 20 shows bills, 21 is a bill passing direction, 32 is an infrared ray sensor element and 33 is an infrared ray LED element.

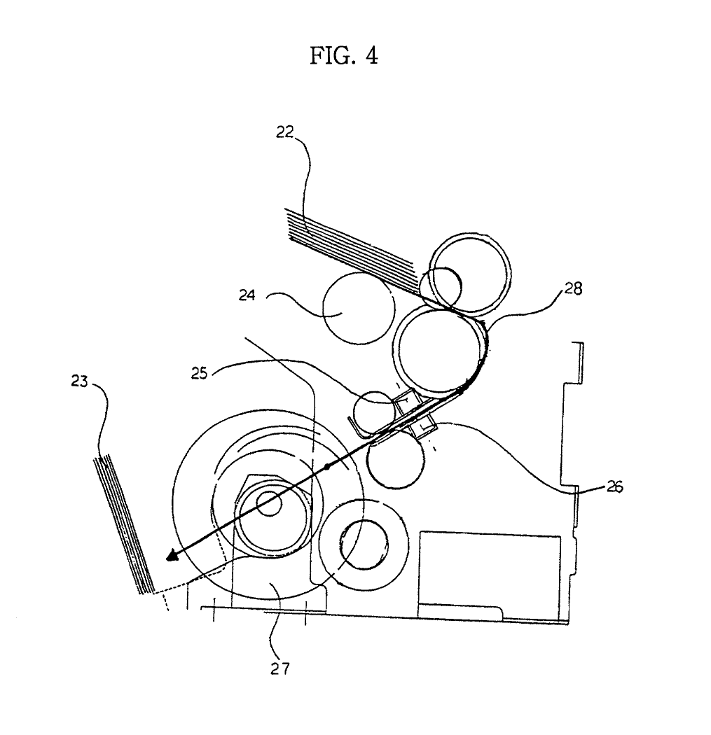

FIG. 4 shows a schematic side view of a bill counter in which the counterfeit bill discriminating device of the present invention is embodied.

The bill counter comprises an input port into which a bundle of bills is inserted, a sensing part, an exhaust port, and a belt. The sensing part transfers the bundle of bills inputted into the input port one by one and discriminates each transferred bill. The exhaust port discharges the bills passing through the sensing part by activating a flywheel 27. The belt delivers a turning force from a power motor to the driving parts. The sensing part includes infrared ray transmitting sensor array and LED array modules and discriminates whether the bill is counterfeit or not.

In other words, when a bundle of bills are inputted into the input port 22, the bills are separated one by one by a roller and passed through the transferring passage 28 between infrared ray transmitting sensor array module 25 and infrared ray transmitting LED array module 26. And then, each bill is discharged through the exhaust port 23 by the flywheel 27. In FIG. 4, reference numeral 24 is a kicker roller.

As of FIG. 1, it is possible to place an image sensor in FIG. 4. In this case, the method for discriminating counterfeit bills is the same as that of FIG. 1 and FIG.2 and will be omitted. However, when fabricating a device with simple structure to prevent cost increase, it is possible to detect counterfeit bills by using only infrared ray transmitting array module. The method will be described hereinafter.

It is possible to calculate the condition of bills through the transferring passage, such as biased degree to right or left and inclined state of bills. This can be done because there are differences between the case when the bill is not in the location and the case when the part of the bill is not printed with special ink.

Like the above description, a reference data is provided in order to recognize whether the detected values from the individual infrared sensors are within the normal range according to the insertion condition of the bill.

And then, the device detects counterfeit bills by comparing detected level of light transmittance characteristics with the reference data. At this stage, since the reference light transmittance level have differences depending on the condition or type of bills, a predetermined allowable range is defined. The device determines that the bill is genuine if the detected light transmittance is within the allowable range. Otherwise it determines that the bill is counterfeit.

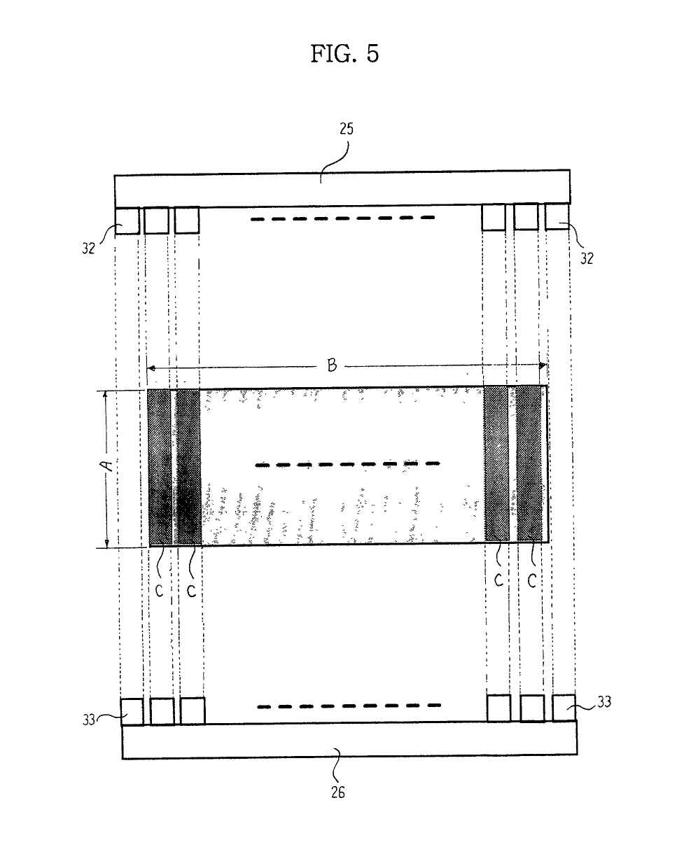

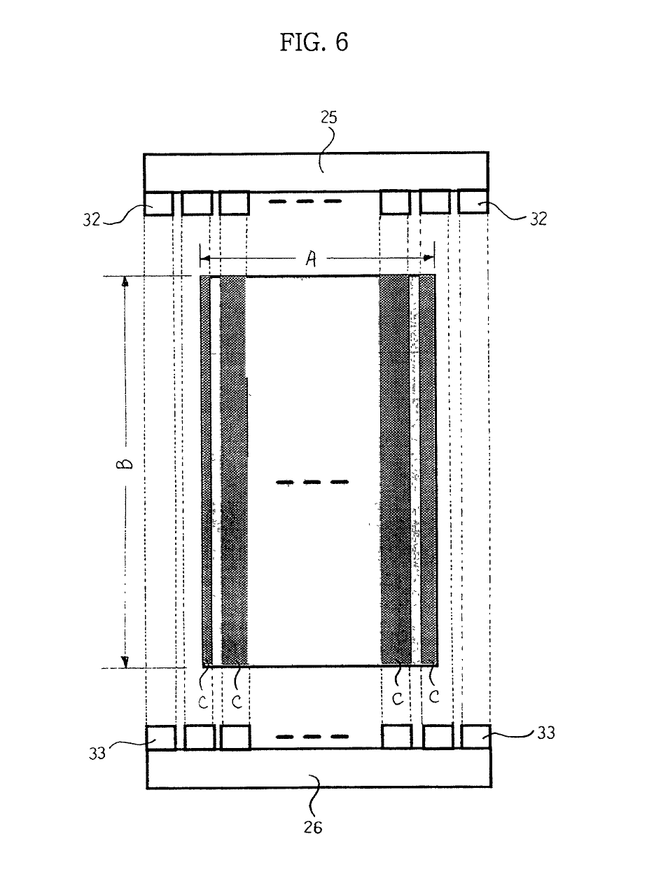

FIG. 5 shows the light transmittance characteristics of the bill when the bill is inputted laterally and FIG. 6 shows the light transmittance characteristics of the bill when the bill is inputted longitudinally.

As illustrated in FIG. 5 and FIG. 6, it is possible to maximize the capability of detecting counterfeit bills by placing sensor array in the middle or anterior surface of bills based on each nation's bill in order to detect the value of infrared ray transmitting in a wider range. In addition, it is possible to have necessary reaction value of the sensor even though locations of inputting bills are biased to right or left or bills that pass through are inclined. Here, A is a long width of a bill, B is a short width of a bill, and C is a light transmittance characteristic detecting range.

As described, the present invention maximizes the capacity of detecting counterfeit bills corresponding to bills of a kind using special ink like infrared ray ink to prevent counterfeit, hidden drawings and/or negatively printed pictures by applying infrared ray transmitting LED array and sensor array modules to automated banking machines such as a bill counter, an automated bill sorter and a counterfeit bills detector.

Especially, since most countries adopt the methods of printing bills using special kind of ink such as infrared ray ink and inserting hidden and/or negatively printed pictures to prevent counterfeit, it is possible to detect counterfeit bills more effectively by using infrared ray transmitting LED array and sensor array modules of the present invention.

What is claimed is:

1. A counterfeit bills discriminating device for discriminating whether the bills are genuine or not, comprising:
an infrared ray emitting array module and an infrared ray receiving array module,
each having therein a predetermined number of infrared ray emitting elements and infrared ray receiving elements disposed in a row with same distance corresponding to a type of currency,
wherein the said receiving array module detect the transmitting characteristics of infrared ray transmitted from a bill passing through a bill transferring passage between the emitting array module and the receiving array module to discriminate the counterfeit bill.

2. The counterfeit bills discriminating device according to claim 1, wherein said emitting elements and receiving elements comprises 8 to 32 elements.

3. The counterfeit bills discriminating device according to claim 1 or 2, wherein said light transmitting characteristics of the bills is with respect to special ink, such as infrared ink, and hidden and/or negative patterns.

4. The counterfeit bills discriminating device according to any of claims 1 to 3, wherein an input direction of the bills is longitudinal or lateral.

5. A method of discriminating counterfeit bills for discriminating whether the bills are genuine or not, comprising the steps of:
providing a counterfeit bills discriminating device comprising an infrared ray emitting array module and an infrared ray receiving array module, each having therein a predetermined number of infrared ray emitting elements and infrared ray receiving elements disposed in a row with same distance corresponding to a type of currency;
and detecting the transmitting characteristics of infrared ray transmitted from a bill passing through a bill transferring passage between the emitting array module and the receiving array module to discriminated the counterfeit bill.

6. The method of discriminating counterfeit bills according to claim 5, wherein said emitting elements and receiving elements comprises 8 to 32 elements.

7. The method of discriminating counterfeit bills according to claim 5 or 6, wherein said light transmitting characteristics of the bills is with respect to special ink, such as infrared ink, and hidden and/or negative patterns.

8. The method of discriminating counterfeit bills according to any of claims 5 to 7, wherein an input direction of the bills is longitudinal or lateral.
